(19) United States
(12) Patent Application Publication
(10) Pub. No.: US 2017/0320094 A1
(43) Pub. Date: Nov. 9, 2017

(54) VIBRATION GENERATOR

(71) Applicant: EURODRILL GmbH, Drolshagen (DE)

(72) Inventor: Markus MERZHAEUSER, Olpe (DE)

(73) Assignee: EURODRILL GmbH, Drolshagen (DE)

(21) Appl. No.: 15/448,198

(22) Filed: Mar. 2, 2017

(30) Foreign Application Priority Data
May 9, 2016 (EP) 16 168 703.3

(51) Int. Cl. B06B 1/18; E02D 7/18

(52) U.S. Cl. CPC B06B 1/186; E02D 7/18

(57) ABSTRACT

The invention relates to a vibration generator having at least one shaft which can be driven in a rotating manner and on which at least one unbalanced unit is arranged that is constructed of at least two weight elements, of which a first weight element is firmly mounted on the shaft and a second weight element is supported in a radially adjustable manner which, depending on the speed of rotation of the shaft, is adjustable between a radially internal first position and a radially external second position. According to the invention a locking means is provided, through which the adjustable second weight element is secured in the first position up to a predetermined triggering speed of rotation of the shaft and, on reaching the triggering speed of rotation, is released and adjustable.

The invention relates to a vibration generator having at least one shaft which can be driven in a rotating manner and on which at least one unbalanced unit is arranged that is constructed of at least two weight elements, of which a first weight element is firmly mounted on the shaft and a second weight element is supported in a radially adjustable manner which, depending on the speed of rotation of the shaft, is adjustable between a radially internal first position and a radially external second position, in accordance with the preamble of claim 1.

Vibration generators are used for example in vibratory pile drivers for driving and extracting sheet piles into or out of the ground. As a result of the generated vibrations that are induced by unbalanced units driven in a rotating manner the ground is brought into a virtually liquid state so that a pile or beam can be pressed into the ground or withdrawn therefrom with relatively little force.

The unbalanced units are driven in a rotating manner by one or several rotary drives using gear transmissions. The unbalanced units and the gear transmission are arranged in a transmission housing, in which case the individual unbalanced units can be adjusted with respect to each other in their angle of rotation by means of an adjusting means. Such vibration generators are known for example from EP 2 085 149 A1, EP 0 951 949 A1 or U.S. Pat. No. 5,955,964 B.

A generic vibration generator can be taken from EP 0 070 343 A1. In these known vibration generators a centrifugal weight guided in a radially movable manner is provided on a revolving unbalanced shaft. Furthermore, a return spring acting on the centrifugal weight is arranged which presses the centrifugal weight into a radially internal position. Thus, in the case of lower speeds of rotation this results in a relatively small unbalance which keeps the starting torque of the drive motor at a low level. With an increasing speed of rotation the centrifugal weight gradually moves under the influence of the centrifugal force contrary to the return spring in an outward direction so that the required unbalance of the vibration generator is only reached when the envisaged operating speed of rotation has been attained. The amount of unbalance therefore changes gradually with an increasing speed of rotation.

The invention is based on the object to provide a vibration generator, in which an improved setting of the amount of unbalance is rendered possible.

In accordance with the invention the object is achieved by a vibration generator having the features of claim 1. Preferred embodiments are stated in the dependent claims.

The vibration generator according to the invention is characterized in that a locking means is provided, through which the adjustable second weight element is secured in the first position up to a predetermined triggering speed of rotation of the shaft and, on reaching the triggering speed of rotation, is released and adjustable. Hence, in the case of the vibration generator according to the invention the amount of unbalance can be held up to a predetermined triggering speed of rotation. Especially during run-up of the vibration generator this permits a constant unbalance. This can facilitate the start-up of the vibration generator in a starting phase and ensures a constant static moment in the start-up phase. In addition, an improved control is also attained, for instance when critical resonance ranges of the vibration generator are run through. In this way, straining or damaging of the vibration generator can be prevented.

A preferred embodiment of the vibration generator according to the invention resides in the fact that the second weight element is supported in a displaceable manner along at least one linear guide which is directed transversely to an axis of rotation of the shaft. The linear guide can be directed radially to the axis of rotation of the shaft or tangentially to a cylindrical surface line around the axis of rotation of the shaft. By preference, two or more linear guides running parallel to each other can also be arranged. Through this, a defined positional displacement of the adjustable second weight element is ensured.

The vibration generator can preferably have several unbalanced units. By preference, at least one pair or several pairs of unbalanced units are provided, wherein the unbalanced units of a pair are each arranged on separate, parallel shafts. The unbalanced units of a pair are driven in opposite directions of rotation. The shafts can be connected via intermeshing gear wheels. By way of an adjusting means, which is designed mechanically by an adjusting shaft or electronically, the rotational position of the unbalanced units of a pair can be changed with respect to each other. Through this, the unbalances can in particular be added up in a vertical direction and compensated in a horizontal direction. In an idling state a compensation in the vertical direction is possible too.

According to an embodiment of the invention it is particularly preferred that the locking means has at least one locking element which is adjustable between a locking position and a release position. The locking element can be a locking pin or a locking hook. In the locking position the locking element is in engagement with the adjustable weight element and fixes its position. On reaching a triggering speed of rotation the locking element can be displaced or pivoted into a release position so that the second weight element is adjusted as a result of the centrifugal force prevailing with the triggering speed of rotation. The triggering speed of rotation is greater than zero and can preferably amount to a value between 10% and 90% of the maximum operating speed of rotation. In the release position the locking element is spaced from the second weight element, thereby allowing free adjustability.

According to a further development of the invention it is especially advantageous that the at least one locking element is adjustable transversely to the linear guide of the second weight element. Preferably, the locking element is a locking pin which is supported in a displaceable manner in a direction transverse to the linear guide.

According to an embodiment variant of the invention it is particularly advantageous that the at least one locking element is held in a spring-tensioned manner in the locking position and to engage in a locking recess on the adjustable second weight element. Through spring pre-tension the locking element is held in the locking position so that the second weight element is reliably held in the radially internal first position. The displacement of the locking element can be effected by an actuator, for instance by an electromagnet. In a particularly robust embodiment the spring pre-tension of the locking element can be designed such that the spring pre-tension of the locking element is overcome by the centrifugal force present with the triggering speed of rotation and the locking element is pressed into the release position. The locking element can be supported in an adjustable manner on the shaft or the weight element.

According to a further development it is especially advantageous that the locking recess has a run-in and/or run-out slope. The run-in or run-out slope can serve as a kind of sliding wedge mechanism, in which the centrifugal force acting on the adjustable second weight element is translated into a counterforce that presses the locking element from the locking position into the release position. A tip of the locking element is designed accordingly with a slope or a rounded portion.

According to an embodiment variant of the invention a particularly reliable locking of the second weight element is achieved in that two locking elements are provided which are directed and displaceable in opposite directions. Hence, a double locking and securing of the second weight element in the locking position is provided.

According to a further development of the invention it is advantageous that at least one resetting spring is provided, through which the second weight element can be reset into the radially internal first position. By preference, the resetting spring is designed with a relatively low resetting spring force so that once the locking means is released the weight element can quickly assume the radially external second position and only when a relatively low resetting speed of rotation has been reached, which is preferably smaller than the triggering speed of rotation, is it reset into the radially internal first position. In this resetting process the weight element can then also be secured again in the first position by the locking means.

In order to limit an excessive increase of the unbalance with a rising speed of rotation it is expedient in accordance with an embodiment variant of the invention that the unbalance of the unbalanced unit is reduced by adjusting the second weight element into the radially external position. In this arrangement the first weight element and the second weight element are arranged contrary to each other with respect to the shaft. On reaching the radially external second position the second weight element thus compensates the unbalance caused by the first weight element.

Alternatively, according to an embodiment of the invention it may be expedient that the unbalance of the unbalanced unit is increased by adjusting the second weight element into the radially external second position. This arrangement is particularly appropriate if for the start-up of the vibration generator only a low or no unbalance is to be present on the shaft in a starting phase. With a starting torque at a relatively low level it is possible to quickly reach a desired operating speed of rotation. When the triggering speed of rotation is exceeded the second weight element is adjusted, wherein the relevant unbalance is formed on the shaft. In this way, a maximum static moment can be generated on the shaft of the unbalanced unit.

Basically, the vibration generator according to the invention can be employed in various fields. In particular, the vibration generator can also be used for soil compaction in a soil compactor.

According to the invention it is particularly preferred that a vibratory pile driver with a carrier is provided, on which a vibration generator according to the invention is supported in a vertically adjustable manner. The carrier can in particular be a crawler-type vehicle, on which the vibration generator is movable along a mast or suspended in a vertically adjustable manner on a rope on a crane boom. The vibration generator has a holding means, more particularly a clamping collet, with which a beam, in particular a sheet pile or an H-beam, that is to be introduced into the ground can be clamped firmly. Via the holding means the vibration generated by the vibration generator can be transmitted to the penetration medium which in turn transmits the vibration to the ground.

Furthermore, according to the invention a drilling apparatus having a drill drive is provided, by which a drill rod can be driven in a rotating manner, wherein a vibration generator according to the invention is provided. With such a drilling apparatus the rotating drilling movement can be superimposed by an axial vibratory movement. As a result, vibratory drilling or also a so-called sonic drilling can be carried out. In the case of such a vibratory drilling an increased drilling progress can be achieved due to the superimposed vibratory movement. The vibration generator is preferably arranged on the drill drive.

The invention is explained in the following by way of a preferred embodiment illustrated schematically in the drawings, wherein show:

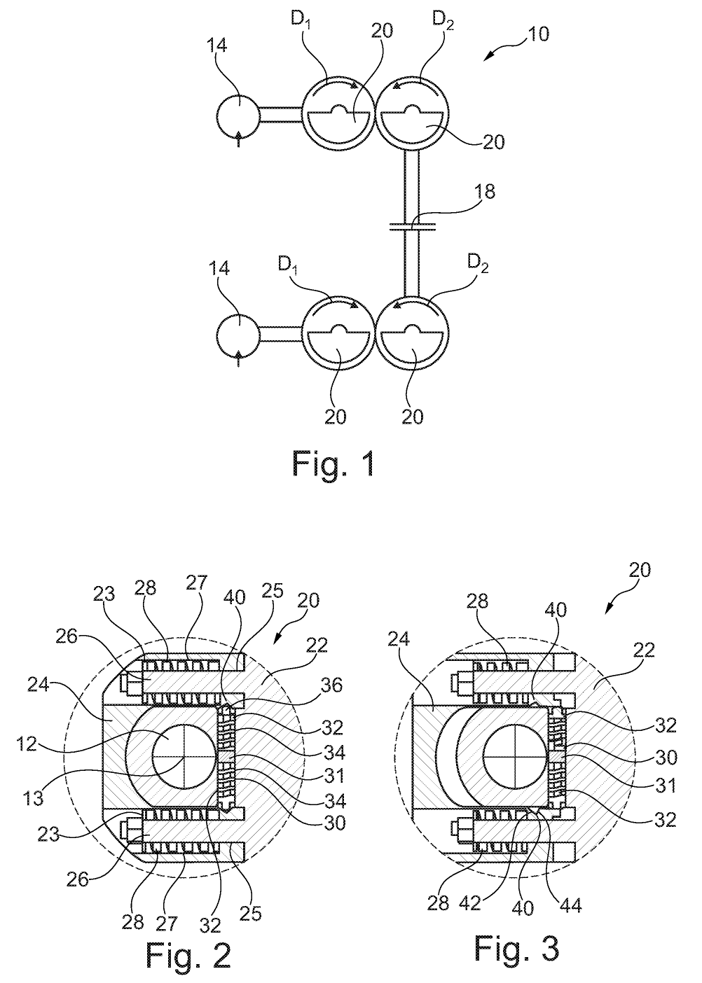

FIG. 1 a schematic illustration of a vibration generator according to the invention;

FIG. 2 a cross-sectional view of an unbalanced unit of a vibration generator according to the invention, in which an adjustable weight element is located in a radially internal first position; and

FIG. 3 a cross-sectional view of the unbalanced unit according to FIG. 2, with the second weight element being located in a radially external second position.

In FIG. 1 the construction of a vibration generator 10 according to the invention with two pairs of unbalanced units 20 is shown in a strongly schematic manner. A first pair of unbalanced units 20 is driven in a rotating manner by a first drive 14 which is designed as a hydraulic motor. By way of gear wheels, not shown, the two unbalanced units 20 of the first pair are connected to each other in a rotating manner, with a first unbalance 20 being driven clockwise in a rotating manner in the direction of rotation D1 and a second unbalanced unit 20 being driven in a rotating manner in the opposite direction of rotation D2. Due to this arrangement the unbalances of both unbalanced units 20 of a pair of unbalances can add up in the vertical direction while compensating each other in the horizontal direction. Accordingly, a second pair of unbalanced units 20 is arranged and driven in a rotating manner by a second drive 14 which is also a hydraulic motor. The two pairs of unbalanced units 20 are coupled via a phase adjusting means 18 which is only indicated schematically and through which an angle of rotation of both pairs of unbalanced units 20 can be adjusted with respect to each other.

The construction of the unbalanced units 20 according to the invention is illustrated and explained in greater detail in conjunction with FIGS. 2 and 3. To form an unbalanced unit 20 on a shaft 12, which is driven in a rotating manner about an axis of rotation 13, a first weight element 22 is arranged on the shaft 12 asymmetrically thereto. Due to the asymmetrical arrangement of the first weight element 22 an unbalance is generated when the unbalanced unit 20 is driven in a rotating manner. To reduce the amount of unbalance a second weight element 24 is supported in an adjustable manner relative to the shaft 12 and the first weight element 22. The second weight element 24 has two parallel directed guide bores 25, with which the second weight element 24 is positioned in a displaceable manner onto two bolt-shaped linear guides 26 directed transversely to the shaft 12 on the first weight element 22. The linear guides 26 each project into an open cylindrical receiving space 27 designed on the second weight element 24. In the receiving space 27 a resetting spring 28 is arranged in each case which is supported on the one hand on a base of the receiving space 27 of the second weight element 24 and on the other hand on a support ring 23. The support ring 23 is respectively arranged at a free end of the bolt-shaped linear guide 26 and is fixed by a screw-nut-like fastening element.

On the first weight element 22 a locking means 30 with two pin-shaped locking elements 32 is arranged in a receiving bore. At their free end the pin-shaped locking elements 32 have a rounded head 36. The locking elements 32 directed transversely to the shaft 12 are tensioned in the outward direction by a tension spring 34. The tension springs 34 are each supported in the inward direction by a center piece 31. Through the tension springs 34 the two locking elements 32 are pressed with their respective head 36 into a locking recess 40 which is of approximately triangular shape in cross section and designed on the adjacent adjustable second weight element 24. Through this, the second weight element 24 is locked in a radially internal first position according to FIG. 2.

With an increasing speed of rotation of the shaft 12 a centrifugal force exerted on the second weight element 24 rises. When a triggering speed of rotation has been reached the locking pins 32 are pressed contrary to the tensioning force of the tension spring 34 by a wedge-shaped run-in slope 42 and a wedge-shaped run-out slope 44 on the locking recess 40 back into the receiving bore of the first weight element 22. As a result, the second weight element 24 is then released and adjustable in the radial direction. Due to the applied centrifugal force the second weight element 24 can assume a radially external second position which is shown in FIG. 3. In this radially external second position the weight of the second weight element 24 is displaced radially outwards in such a manner that the asymmetrical weight distribution of the first weight element 22 is compensated partially and thus the unbalance is reduced.

During radial outward displacement the resetting spring 28 is compressed and tensioned. Hence, when the speed of rotation of the shaft 12 is reduced the second weight element 24 can be pressed back into the radially internal first position according to FIG. 2. On reaching the first starting position the pin-shaped locking elements 32 are once again pressed by the respective tension springs 34 in the outward direction into the opposite locking recesses 40 on the second weight element 24.

1. Vibration generator,
having at least one shaft which can be driven in a rotating manner and on which at least one unbalanced unit is arranged that is constructed of at least two weight elements, of which a first weight element is firmly mounted on the shaft and a second weight element is supported in a radially adjustable manner which, depending on the speed of rotation of the shaft, is adjustable between a radially internal first position and a radially external second position,
wherein
a locking means is provided, through which the adjustable second weight element is secured in the first position up to a predetermined triggering speed of rotation of the shaft and, on reaching the triggering speed of rotation, is released and adjustable.

2. Vibration generator according to claim 1,
wherein
the second weight element is supported in a displaceable manner along at least one linear guide which is directed transversely to an axis of rotation of the shaft.

3. Vibration generator according to claim 1,
wherein
the locking means has at least one locking element which is adjustable between a locking position and a release position.

4. Vibration generator according to claim 3,
wherein
the at least one locking element is adjustable transversely to the linear guide of the second weight element.

5. Vibration generator according to claim 3,
wherein
the at least one locking element is held in a spring-tensioned manner in the locking position and engages in a locking recess on the adjustable second weight element.

6. Vibration generator according to claim 5,
wherein
the locking recess has a run-in and/or run-out slope.

7. Vibration generator according to claim 3,
wherein
two locking elements are provided which are directed and displaceable in opposite directions.

8. Vibration generator according to claim 1,
wherein
at least one resetting spring is provided, through which the second weight element can be reset into the radially internal first position.

9. Vibration generator according to claim 1,
wherein
the unbalance of the unbalanced unit is reduced by adjusting the second weight element into the radially external second position.

10. Vibration generator according to claim 1,
wherein
the unbalance of the unbalanced unit is increased by adjusting the second weight element into the radially external second position.

11. Vibratory pile driver having a carrier, on which a vibration generator is supported in a vertically adjustable manner,
wherein
a vibration generator according to claim 1 is provided.

12. Drilling apparatus having a drill drive, by which a drill rod can be driven in a rotating manner,
wherein
a vibration generator according to claim 1 is provided.
